(19) United States
(12) Patent Application Publication
(10) Pub. No.: US 2011/0267538 A1
(43) Pub. Date: Nov. 3, 2011

(54) SYSTEM AND METHOD FOR ALTERING IMAGES IN A VIDEO FILE USING PREDETERMINED PARAMETERS

(76) Inventor: Fatehali T. Dharssi, Vancouver (CA)

(21) Appl. No.: 12/770,101

(22) Filed: Apr. 29, 2010

(51) Int. Cl. H04N 5/14

(52) U.S. Cl. 348/576; 348/E05.062

(57) ABSTRACT

A system and method for altering images using predetermined parameters is provided, through the use of a record associated with a digital video file. The record contains a number of parameters about insertion opportunities, including the location, time span, and shape of such opportunities. When a digital video file is requested, the record is accessed, and a determination is made as to whether the file should be altered. Should the determination be made for an alteration, a distinctive image is selected based on the information, including the parameters in the record, and an insertion or substitution is made.

### FIELD OF THE INVENTION

This invention relates to digital video, such as that available via the Internet, and more particularly to altering and substituting images in such digitized videos.

### BACKGROUND

Advertising in video, such as a television (TV) program, is primarily accomplished by either placing a conventional advertisement in commercial breaks during the display of the TV program (which is an explicit means of advertising) or, by placing a product in the scenes of the video in which the product appears as “naturally” part of the scene, and is not being explicitly advertised (this form of advertising is known as “implicit advertising”). As advertising becomes more cluttered on TV and on the Internet, and with the increasing ability of video viewers (i.e. intended consumers of the advertisers) to avoid such advertising using digital video recorders (DVRs) and other means, the demand for implicit advertising continues to grow.

The market for implicit advertising has been valued at over $4 billion in 2005, and has been growing at over 20% per year. Today, product placements appear in TV shows, films, video games, and new media such as the online virtual world known as Second Life.

Typically, products placed in videos as implicit advertising are placed when the video is filmed or made. Another method adds a flash movie layer to a streaming video format to provide interactivity to the video, thereby allowing users to scroll over or click on elements within the video to obtain more information. Once the video is released for viewing, there lacks a means to identify, locate, replace, supplement or otherwise alter the original product placed in the streaming video.

### SUMMARY OF THE INVENTION

A method of altering a distinctive image within a digital video file is provided, including the steps: (a) receiving a request for the digital video file; (b) accessing a record associated with the digital file, the record including information to determine the location of the distinctive image within the digital video file, the time in which the distinctive image occurs in the digital video and the dimensions of the distinctive image; (c) selecting a substitute distinctive image based on the record and a second record relating to a computer associated with the request; (d) substituting the substitute distinctive image for the first distinctive image; and (e) transmitting the digital video file to the computer.

A method of inserting a distinctive image within a digital video file is provided, including: (a) receiving a request for the digital video file; (b) accessing a record associated with the digital file, the record including information to determine an insertion opportunity having a location of a potential distinctive image within the digital video file, a time, and dimensions of the location; (c) selecting the distinctive image based on said record and a second record relating to a computer associated with said request; (d) inserting the distinctive image in the video file; and (f) transmitting the digital video file to the computer.

A distinctive image to be altered may be altered to correspond to parameters within the record. A distinctive image may include a trade-mark.

The record may also include further information about a background color associated with a distinctive image. The record may further include information about a shade associated with a distinctive image; information about movement of an insertion opportunity; information about the angle of an insertion opportunity relative to a horizontal edge over time; information about the angle of an insertion opportunity relative to a vertical edge over time; or information about an audio component of a digital file relating to an insertion opportunity and time.

### BRIEF DESCRIPTION OF THE FIGURES

FIG. 1 is a block diagram showing a system wherein the invention may be practiced;

FIG. 2 is a block diagram showing components of a record associated with a video file;

FIGS. 3a to 3c are examples of a video screen shot showing the effect of the parameters in making an image substitution;

FIG. 4 is a flow chart showing an insertion process; and

FIG. 5 is a block diagram of a computer system embodying a method of a carrying out the invention.

### DETAILED DESCRIPTION OF THE INVENTION

The system and method according to the invention provide a means whereby distinctive images, such as trade-marks (i.e. brand names and/or logos), Universal Product Codes (UPC), or locations wherein other distinctive images can be inserted, are identified and located within a digital video file, and then a distinctive image is inserted, replaced, supplemented, added to or otherwise altered from what appeared in the original digital video file. A “digital video file”, also referred to herein as “video file”, is defined in this document as data which can be processed by a computer to produce one or more color pictures or images, motion video, or moving pictures. A digital video file may be copied to a computer before being viewed, or may be viewed as a computer is downloading the digital video file, as in the case of streaming video.

As used in this document a “distinctive image” means a recognizable image viewable within a digital video file. Distinctive images include trade-marks, addresses, and even the entire shapes of certain objects, such as road signs, cellular phones, product images, cereal boxes and room design, layout and decor.

The following discussion provides a brief and general description of a suitable computing environment in which various embodiments of the system may be implemented. Although not required, embodiments will be described in the general context of computer-executable instructions, such as program applications, modules, objects or macros being executed by a computer. Those skilled in the relevant art will appreciate that the invention, or components thereof, can be practiced with other computing system configurations, including hand-held devices, multiprocessor systems, microprocessor-based or programmable consumer electronics, personal computers (“PCs”), network PCs, mini-computers, mainframe computers, mobile phones, smart phones, personal digital assistants, personal music players (like IPOD's) and the like. The embodiments can be practiced in distributed computing environments where tasks or modules are performed by remote processing devices, which are linked through a communications network. In a distributed computing environment, program modules may be located in both local and remote memory storage devices.

As used herein, the terms “computer” and “server” are both computing systems as described in the following. A computing system may be used as a server including one or more processing units, system memories, and system buses that couple various system components including system memory to a processing unit. Computing system will at times be referred to in the singular herein, but this is not intended to limit the application to a single computing system since in typical embodiments, there will be more than one computing system or other device involved. Other computing systems may be employed, such as conventional and personal computers, where the size or scale of the system allows. The processing unit may be any logic processing unit, such as one or more central processing units (“CPUs”), digital signal processors (“DSPs”), application-specific integrated circuits (“ASICs”), etc. Unless described otherwise, the construction and operation of the various components are of conventional design. As a result, such components need not be described in further detail herein, as they will be understood by those skilled in the relevant art.

The computing system includes a system bus that can employ any known bus structures or architectures, including a memory bus with memory controller, a peripheral bus, and a local bus. The system also will have a memory which may include read-only memory (“ROM”) and random access memory (“RAM”). A basic input/output system (“BIOS”), which can form part of the ROM, contains basic routines that help transfer information between elements within the computing system, such as during startup.

The computing system also includes non-volatile memory. The non-volatile memory may take a variety of forms, for example a hard disk drive for reading from and writing to a hard disk, and an optical disk drive and a magnetic disk drive for reading from and writing to removable optical disks and magnetic disks, respectively. The optical disk can be a CD-ROM or BLU-RAY, while the magnetic disk can be a magnetic floppy disk or diskette. The hard disk drive, optical disk drive and magnetic disk drive communicate with the processing unit via the system bus. The hard disk drive, optical disk drive and magnetic disk drive may include appropriate interfaces or controllers coupled between such drives and the system bus, as is known by those skilled in the relevant art. The drives, and their associated computer-readable media, provide non-volatile storage of computer readable instructions, data structures, program modules and other data for the computing system. Although computing systems may employ hard disks, optical disks and/or magnetic disks, those skilled in the relevant art will appreciate that other types of non-volatile computer-readable media that can store data accessible by a computer may be employed, such a magnetic cassettes, flash memory cards, digital video disks (“DVD”), Bernoulli cartridges, RAMs, ROMs, smart cards, etc.

Various program modules or application programs and/or data can be stored in the system memory. For example, the system memory may store an operating system, end user application interfaces, server applications, and one or more application program interfaces (“APIs”).

The system memory also includes one or more networking applications, for example a Web server application and/or Web client or browser application for permitting the computing system to exchange data with sources, such as clients operated by users and members via the Internet, corporate Intranets, or other networks as described below, as well as with other server applications on servers such as those further discussed below. The networking application in the preferred embodiment is markup language based, such as hypertext markup language (“HTML”), extensible markup language (“XML”) or wireless markup language (“WML”), and operates with markup languages that use syntactically delimited characters added to the data of a document to represent the structure of the document. A number of Web server applications and Web client or browser applications are commercially available, such those available from Mozilla and Microsoft.

The operating system and various applications/modules and/or data can be stored on the hard disk of the hard disk drive, the optical disk of the optical disk drive and/or the magnetic disk of the magnetic disk drive.

A computing system can operate in a networked environment using logical connections to one or more client computing systems and/or one or more database systems, such as one or more remote computers or networks. The computing system may be logically connected to one or more client computing systems and/or database systems under any known method of permitting computers to communicate, for example through a network such as a local area network (“LAN”) and/or a wide area network (“WAN”) including, for example, the Internet. Such networking environments are well known, including wired and wireless enterprise-wide computer networks, intranets, extranets, and the Internet. Other embodiments include other types of communication networks such as telecommunications networks, cellular networks, paging networks, and other mobile networks. The information sent or received via the communications channel may, or may not be encrypted. When used in a LAN networking environment, the computing system is connected to the LAN through an adapter or network interface card (communicatively linked to the system bus). When used in a WAN networking environment, the computing system may include an interface and modem (not shown) or other device, such as a network interface card, for establishing communications over the WAN/Internet.

In a networked environment, program modules, application programs, or data, or portions thereof, can be stored in the computing system for provision to the networked computers. In one embodiment, the computing system is communicatively linked through a network with TCP/IP middle layer network protocols; however, other similar network protocol layers are used in other embodiments, such as user datagram protocol (“UDP”). Those skilled in the relevant art will readily recognize that these network connections are only some examples of establishing communications links between computers, and other links may be used, including wireless links.

While in most instances the computing system will operate automatically, where an end user application interface is provided, an operator can enter commands and information into the computing system through an end user application interface including input devices, such as a keyboard, and a pointing device, such as a mouse. Other input devices can include a microphone, joystick, scanner, etc. These and other input devices are connected to the processing unit through the end user application interface, such as a serial port interface that couples to the system bus, although other interfaces, such as a parallel port, a game port, or a wireless interface, or a universal serial bus (“USB”) can be used. A monitor or other display device is coupled to the bus via a video interface, such as a video adapter (not shown). The computing system can include other output devices, such as speakers, printers, etc.

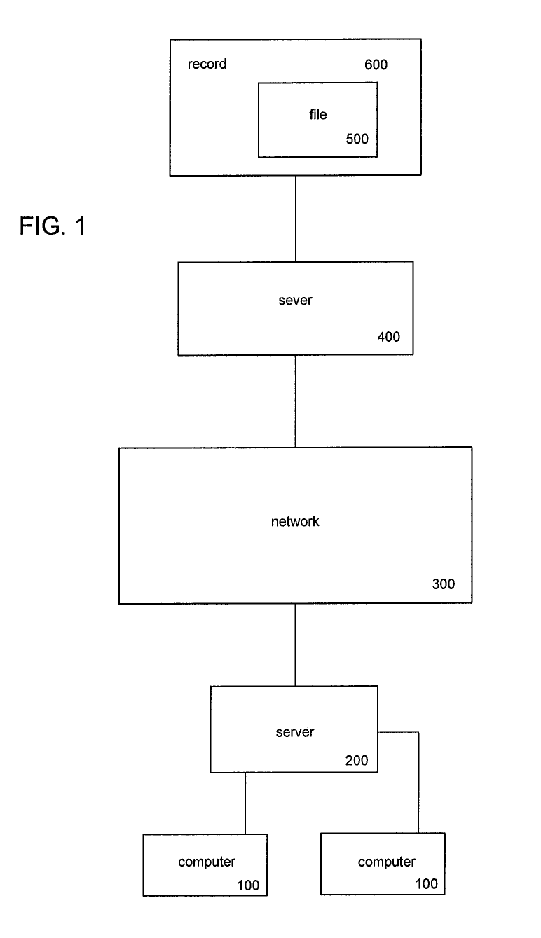

As seen in FIG. 1, a typical embodiment of a system according to the invention is shown. A user operates a computer 100 capable of playing digital video, such as streaming video. Computer 100 is a computing system as described above, and has a network link and software and/or hardware to play and display videos from one or more servers 400 accessible via network 300. Computer 100 is typically connected to network via a second server 200. Server 200 may be operated by an Internet Service Provider (ISP). Server 200 communicates and exchanges files with other servers 400 in communication with network 300. Network 300 may be the Internet, but may also be a LAN, or WAN.

When a digital video file 500, which may be streaming video, is requested by computer 100, server 200 requests the file 500 from server 400, and server 400 responds by providing file 500 to server 200, and then to computer 100. File 500 thus passes through several computers or servers, including several that may be in network 300, each of which has the opportunity to alter video file 500 according to its instructions. For example, computer 100 may alter video file 500 by inserting or substituting a distinctive image, for example substituting a trade-marked good such as a trade-marked can, with another. This insertion or substitution may be at the request of the owner of both trade-marks, for example in the case where the original trade-mark is not available in the geographic region of the user, and therefore advertising efforts using the original trade-mark will likely be wasted.

Video file 500 is typically in server 400′s memory as part of record 600 within a database. Record 600 may contain a variety of data about video file 500, and may also contain information about users as described below. If the change to file 500 is not made at server 400, record 600 may be transmitted with video file 500.

There are several other locations where the alteration may be made. For example, a trunk line along which the files 500 are transmitted; or on server 400, for example if server 400 hosts a website displaying videos, such as YOUTUBE, whereat the public can post and view video files. The method allows providers of such websites to digitally and electronically insert product or brand images into videos before these are viewed by the public and to sell this service as product placement advertising. The alteration could also be conducted on a server 400 of a search engine, such as GOOGLE, where the method could be used to alter a brand image on any electronic picture or video communication. The alteration could also be conducted on a server 400 of a mobile phone company or at a mobile phone, wherein the method could be used to alter a distinctive image on any electronic picture or video communication. Alternatively ISP server 200 could alter video file 500, for example based on the geographic location of computer 100.

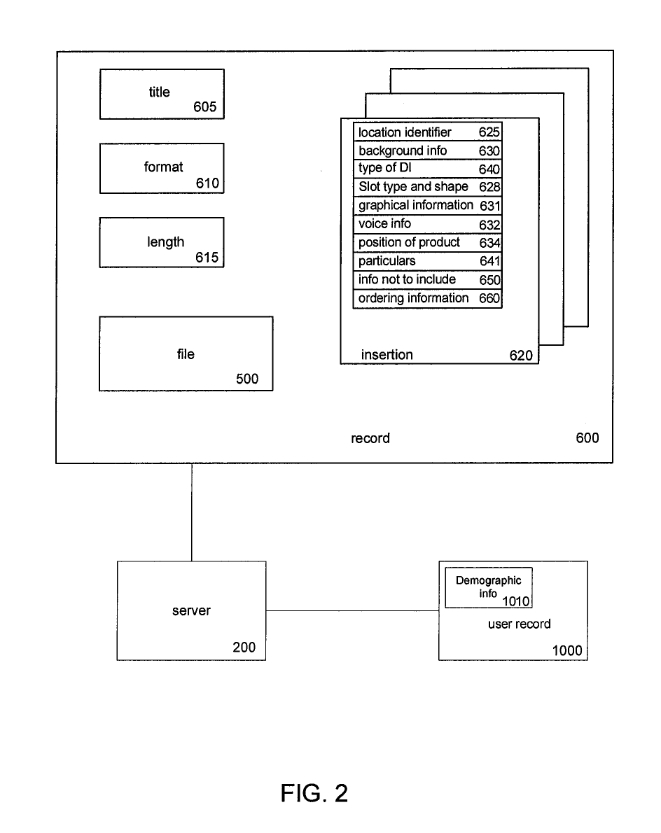

Record 600, as shown in FIG. 2, has several fields containing parameters related to video file 500. Several fields are related to the video file as a whole, e.g. title 605, format 610, and length 615. A series of fields are based on insertion opportunities, in the sub record insertion 620. Each insertion sub record 620 provides an indication of an opportunity for insertion of a distinctive image(s) or replacement of a distinctive image within the video data, with substitute data showing a different distinctive image (or alternatively removing the distinctive image).

Insertion sub record 620 may include any or all of the following fields:

Location identifier 625 includes information about the time and location the distinctive image is present or at which a distinctive image can be inserted. The location includes the dimensions of a current or potential distinctive image with respect to time. For example, the distinctive image, at a particular time Tᵢ, may take the space bounded by the corners, Xᵢ, Yᵢ and Xⱼ, Yⱼ. Of course, the location of a distinctive image may be more complex, as it may appear in a variety of shapes, for example a cylinder, and be visible at several different angles throughout the video. The time can be defined by a start and end time, a series of frame numbers or by a location identifier data that is inserted in the video (e.g. a letter “X” in the bottom right corner in frame 23 through frame 38 can show where and for long the insertion can be made).

Slot type and slot shape 628 includes information about the type of shape of the insertion opportunity, e.g. square, rectangle, circle, cylinder, cube, etc., and size. An example of size would be geometric/mathematical data (e.g. a circle where the diameter is x % of width of frame). Another indication could be that the insertion opportunity is the same size as a product currently shown in video (useful for example, when changing a one liter can having a first trade-mark to one having a second trade-mark).

Background information 630 includes information about the context in which the distinctive image is or can be located. As used herein the term “context” means the set of circumstances or facts relating to a particular image. This may include information about the scene itself, such as the activities of the characters, as well as information about the placement of the distinctive image, such as “on a table”, or “next to a fridge”, or “in a bedroom”. Information about the literal background may also be included, such as “in front of blue wall”. Also, information about the general location of the scene, e.g. “in New York”, or “in Paris”, may be included.

Graphical information 631 includes the pictorial/graphical background of the video image like color, shade, etc., so that when inserting or substituting a distinctive image the aesthetic characteristics of the video file are preserved and do not become degraded. Graphical characteristics may include color, shade, background color, and edge/border color to allow a distinctive image to blend into the video, etc. The colors (especially background colors) could be precisely defined (e.g. 36A on specified color charts) so that the insertion of a product blends with the rest of the video.

Voice information 632 includes definitions of any voice parameters that are required to be changed to make the insertion consistent (e.g. if the audio portion of the video talks of a “COKE can”, then any insertion has to make this audio consistent with the new image inserted, additionally, the parameters may restrict insertion to only soda beverages so that the sound items do not become inconsistent with changes to the image).

Position of product in insertion opportunity 634 may include “slanted” (and defining an angle against the horizontal and vertical planes); perpendicular/straight to horizontal surface or the angle if not; “standing”, flat or on its side; or movement (e.g. a can maybe rolling on the counter).

Type of distinctive image 640 includes a description of the distinctive image, such as a product, which may include both narrow (e.g. “a can of PEPSI”), and broad (e.g. “a can, which may be holding a beverage”) information about the distinctive image. Using this information, an appropriate substitution can be made, for example by substituting one can for another.

Particulars of distinctive image for insertion 641 includes information about the image, such as “open”, “closed”, “showing actual product inside package”, “soda pouring from can”, etc.

Type of distinctive image that should not be included 650 may include products or materials that the video owner, an advertiser or a viewing location owner may not want substituted in the video. Examples could included cigarettes, sex related items, a duplicate product (for example if a cup of coffee is already in the video, it may not be appropriate to include another cup of coffee, perhaps because of an exclusivity arrangement with the coffee provider, or perhaps for consistency, i.e. only one provider should appear in the video).

Ordering information 660 includes information about products in the video, and how a viewer can purchase such products. This may include links, etc., to which the user can access a web site from which to purchase, and perhaps coupons or the like providing the user a discount. The above parameters may be defined for the whole segment on the video comprising this product or maybe defined by each sub-segment (as defined by frame or by time) of the video.

Other information in user record 1000 should be accessible about the computer 100 requesting the video. This information may be stored in server 200, server 400 or computer 100, depending on where the alteration takes place. User record 1000 may include demographic information 1010 which may include age, income, geographic location, interests, purchase behavior, political affiliation, sex, etc. Household information, information about computer 100, and other information may be included. This information allows for an appropriate insertion or targeted substitution of a distinctive image.

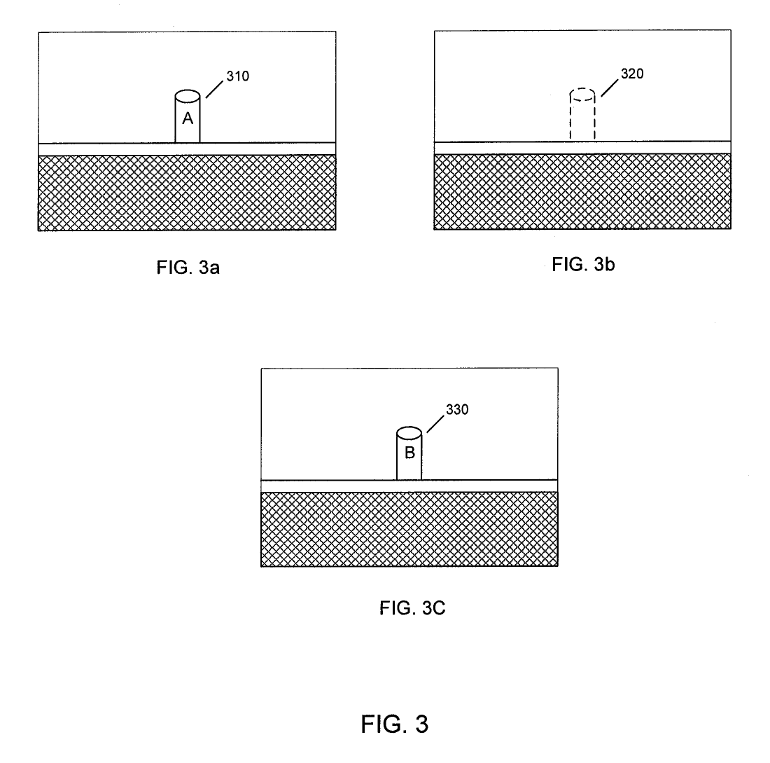

An example of the use of such a system could be when a user requests video file 500 from server 200. When uploading the file 500, the provider of the video asks a number of questions about the user, which allows the provider to make substitutions as appropriate based on the answers to the questions and the identifiers associated with the video record. These questions may be “asked” and answers proved in the review and exchange of electronic records, such as cookies, or questions may be provided to be completed by the user. As an example, FIG. 3a shows a counter on which a distinctive image, can 310, is positioned. Can 310 is branded with a trade-mark “A”. The parameters associated with can 310 are represented by the dashed lines shown in FIG. 3b.

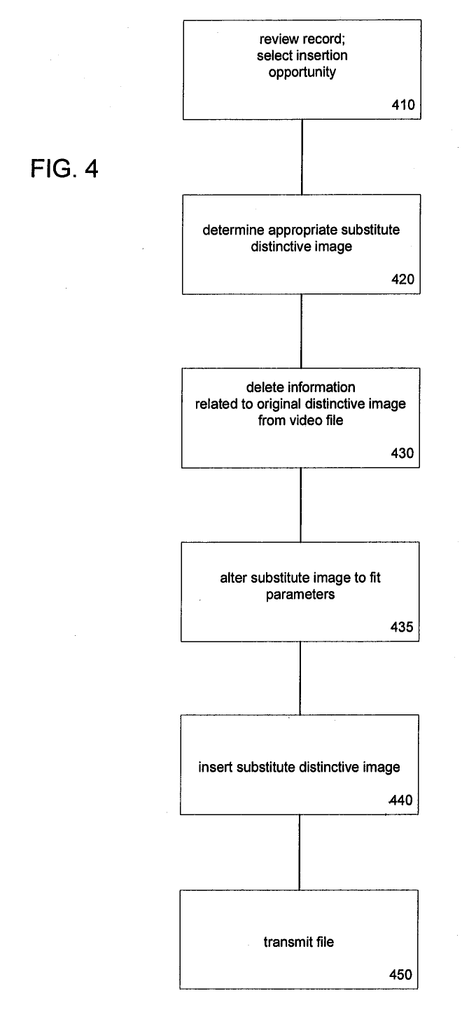

The method, as seen in FIG. 4, begins with reviewing the record and selecting an insertion opportunity (step 410) for video file 500. The parameters associated with the insertion opportunity are determined through review of record 600, and the information 320 received is as shown in FIG. 3b. These parameters are used, in conjunction with user record 1000 to determine an appropriate substitute distinctive image (step 420).

Once the substitute distinctive image is located, video file 500 is changed to delete the information related to the original distinctive image (step 430) as indicated in record 600, and as shown in FIG. 3c, wherein the can marked with “A” has been substituted by a can 330 marked with “B”. The new distinctive image fits exactly where the old distinctive image had been located. The information about the substitute distinctive image may then altered to correspond to record 600; for example, the length of display, the size, and the location in the digital video file are amended to correspond to the first distinctive image (step 435). Then information about the substitute distinctive image is inserted (step 440).

Finally, the video file 500 is sent to computer 100 for viewing (step 450). At this step, ordering information 660 can be used to provide information to a user to make purchases or obtain more information about products displayed in video file 500. The ordering information may be related to the substitute or potential distinctive image, rather than a distinctive image originally displayed in video file 500. Depending on the device on which the video is being viewed, the user may be able to touch a portion of the screen showing the product with their finger, or a mouse click, which will pause the video and divert the user to link to coupons, or to web sites and the like which provide information or allow the user to purchase the product. Alternatively, the user can have the opportunity to view the original video file 500, without substitutions.

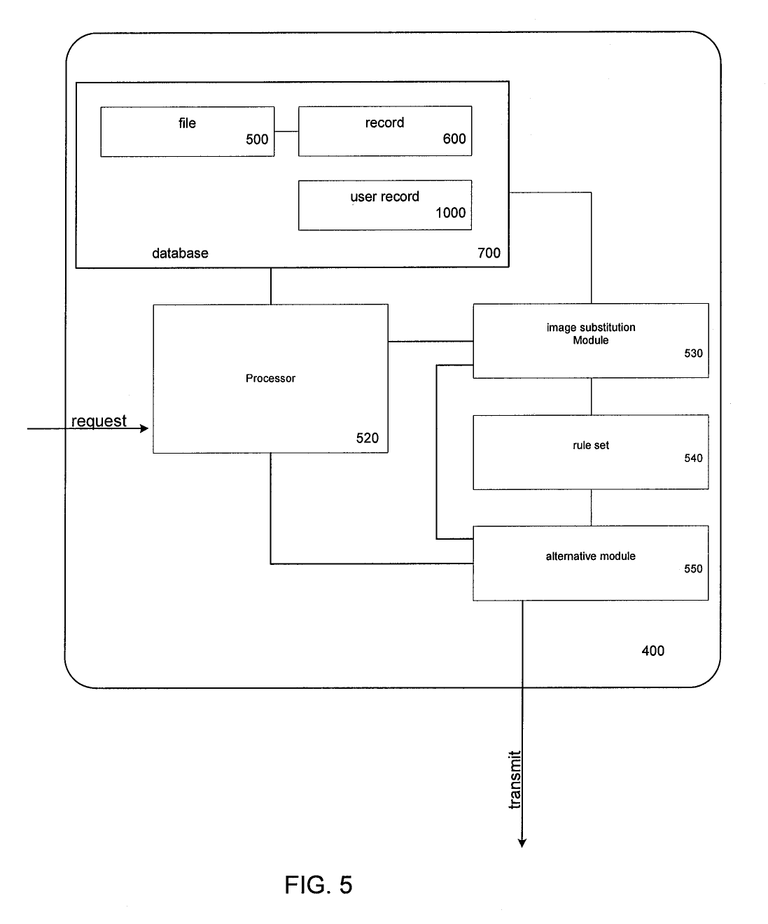

As shown in FIG. 5, the process by which distinctive images are located and altered in digital video file 500 can be done in a computer, such as server 400. A request for digital video file 500 reaches processor 520 in server 400, and database 700 is accessed to obtain record 600 associated with digital video file 500.

The method of inserting or altering distinctive images in server 400 can be carried out by a series of modules, which may be implemented in hardware or software. Image substitution module 530, accesses database 700 to obtain data according to record 600. Rule set 540 provides instructions to image recognition module 530 based on information in record 600 and in user record 1000, as well as other available information, such as the time of day and IP address. The instructions from rule set 540 include information about which distinctive images in video file 500 to remove. Image substitution module 530 then scans record 600 for such distinctive images and reports to alteration module 550 regarding the success of such scan and which distinctive images, if any, to remove from digital video file 500.

Alteration module 550 provides information to rule set 540 regarding the distinctive image to be removed, and based on instructions from rule set 540 alters digital video file 500 accordingly. Several alterations to digital video file 500 may be made, depending on the distinctive images to be removed. After being altered, the altered digital video file 500 is sent to the requestor, and it may also be saved in database 510.

Alternatively, the alteration may be an insertion of a distinctive image. An example of the use of an insertion opportunity in which to insert a distinctive image could be a video file showing scenes of a kitchen in which the kitchen counter is not showing branded products placed on the counter. In such a situation, the record 600 includes the needed data, such as the size of a location; the position of the location; the time the location is available (and/or which frames of video); background color; whether the product is opened, and if opened how opened; and what products are allowed and not allowed for insertion. Then an insertion can be made, for example for an opened can of a branded coffee.

Alternatively, there may already be a can of branded coffee on the counter in the video file, and the data associated with the insertion opportunity in the record may indicate that the coffee can may be substituted by a package of any type of branded food, beverage product, or another food product image can be placed adjacent to the coffee can. Therefore, one could substitute a branded bottle image in place of the coffee can image and insert a branded orange juice bottle image in the video file.

As will be apparent to those skilled in the art, the various embodiments described above can be combined to provide further embodiments. Aspects of the present systems, methods and components can be modified, if necessary, to employ systems, methods, components and concepts to provide yet further embodiments of the invention. For example, the various methods described above may omit some acts, include other acts, and/or execute acts in a different order than set out in the illustrated embodiments.

The present methods, systems and articles also may be implemented as a computer program product that comprises a computer program mechanism embedded in a computer readable storage medium. For instance, the computer program product could contain program modules. These program modules may be stored on CD-ROM, DVD, magnetic disk storage product, flash media or any other computer readable data or program storage product. The software modules in the computer program product may also be distributed electronically, via the Internet or otherwise, by transmission of a data signal (in which the software modules are embedded) such as embodied in a carrier wave.

For instance, the foregoing detailed description has set forth various embodiments of the devices and/or processes via the use of examples. Insofar as such examples contain one or more functions and/or operations, it will be understood by those skilled in the art that each function and/or operation within such examples can be implemented, individually and/or collectively, by a wide range of hardware, software, firmware, or virtually any combination thereof. In one embodiment, the present subject matter may be implemented via Application Specific Integrated Circuits (ASICs). However, those skilled in the art will recognize that the embodiments disclosed herein, in whole or in part, can be equivalently implemented in standard integrated circuits, as one or more computer programs running on one or more computers (e.g., as one or more programs running on one or more computer systems), as one or more programs running on one or more controllers (e.g., microcontrollers) as one or more programs running on one or more processors (e.g., microprocessors), as firmware, or as virtually any combination thereof, and that designing the circuitry and/or writing the code for the software and or firmware would be well within the skill of one of ordinary skill in the art in light of this disclosure.

In addition, those skilled in the art will appreciate that the mechanisms taught herein are capable of being distributed as a computer program product in a variety of forms, and that an illustrative embodiment applies equally regardless of the particular type of signal bearing media used to actually carry out the distribution. Examples of signal bearing media include, but are not limited to, the following: recordable type media such as floppy disks, hard disk drives, CD ROMs, digital tape, flash drives and computer memory; and transmission type media such as digital and analog communication links using TDM or IP based communication links (e.g., packet links).

Further, in the methods taught herein, the various acts may be performed in a different order than that illustrated and described. Additionally, the methods can omit some acts, and/or employ additional acts.

These and other changes can be made to the present systems, methods and articles in light of the above description. In general, in the following claims, the terms used should not be construed to limit the invention to the specific embodiments disclosed in the specification and the claims, but should be construed to include all possible embodiments along with the full scope of equivalents to which such claims are entitled. Accordingly, the invention is not limited by the disclosure, but instead its scope is to be determined entirely by the following claims.

While certain aspects of the invention are presented below in certain claim forms, the inventors contemplate the various aspects of the invention in any available claim form. For example, while only some aspects of the invention may currently be recited as being embodied in a computer-readable medium, other aspects may likewise be so embodied.

I claim:

1. A method of altering a distinctive image within a digital video file, comprising:
a) receiving a request for said digital video file;
a) accessing a record associated with said digital file, said record including information to determine the location of said distinctive image within said digital video file, the time in which said distinctive image occurs in said digital video and the dimensions of said distinctive image;
b) selecting a substitute distinctive image based on said record and a second record relating to a computer associated with said request;
c) substituting said substitute distinctive image for said first distinctive image; and
d) transmitting said digital video file to said computer.

2. The method of claim 1 wherein said substitute distinctive image is altered according to correspond to said information about said first distinctive image.

3. The method of claim 1 wherein the distinctive image is a trade-mark.

4. The method of claim 2 wherein said record further includes information about a background color associated with said distinctive image.

5. The method of claim 4 wherein said record further includes information about a shade associated with said distinctive image/

6.

6. The method of claim 5 wherein said record further includes information about movement of said distinctive image.

7. The method of claim 6 wherein said record includes information about the angle of said distinctive image relative to a horizontal edge over time.

8. The method of claim 7 wherein said record includes information about the angle of said distinctive image relative to a vertical edge over time.

9. The method of claim 8 wherein said record includes information about an audio component of said digital file relating to said distinctive image.

10. The method of claim 9 wherein said second record includes information relating to purchase behavior associated with a user associated with said computer.

11. The method of claim 10 wherein said second record also includes information relating to demographic information about said user.

12. A method of inserting a distinctive image within a digital video file, comprising:
a) receiving a request for said digital video file;
a) accessing a record associated with said digital file, said record including information to determine an insertion opportunity having a location of a potential distinctive image within said digital video file, a time, and dimensions of said location;
b) selecting the distinctive image based on said record and a second record relating to a computer associated with said request;
c) inserting the distinctive image in said video file; and
e) transmitting said digital video file to said computer.

13. The method of claim 12 wherein said distinctive image is altered to correspond to said record.

14. The method of claim 12 wherein the distinctive image includes a trade-mark.

15. The method of claim 13 wherein said record further includes information about a background color associated with said distinctive image.

16. The method of claim 15 wherein said record further includes information about a shade associated with said distinctive image

17. The method of claim 16 wherein said record further includes information about movement of said insertion opportunity.

18. The method of claim 17 wherein said record includes information about the angle of said insertion opportunity relative to a horizontal edge over time.

19. The method of claim 18 wherein said record includes information about the angle of said insertion opportunity relative to a vertical edge over time.

20. The method of claim 19 wherein said record includes information about an audio component of said digital file relating to said insertion opportunity and said time.

21. A system of altering a digital video file, comprising:
a) a computer, said computer receiving a request for said digital video file;
a) a database accessible by said computer, said database containing a record associated with said digital file, said record including information to determine the location of a distinctive image within said digital video file, the time in which said distinctive image occurs in said digital video and the dimensions of said distinctive image;
b) an image substitution module for selecting a substitute distinctive image based on said record, a rule set, and a second record relating to a computer associated with said request; and for substituting said substitute distinctive image for said first distinctive image.
